(19) United States
(12) Patent Application Publication
(10) Pub. No.: US 2011/0197706 A1
(43) Pub. Date: Aug. 18, 2011

(54) DEVICE TO GUARD AN END OF A ROTATING SHAFT OR BEARING

(76) Inventor: Alan Dean Matthes, Monroe, MI (US)

(21) Appl. No.: 12/708,470

(22) Filed: Feb. 18, 2010

(51) Int. Cl. F16P 1/00

(52) U.S. Cl. 74/609

(57) ABSTRACT

The present disclosure describes a device for guarding an end of a rotating shaft or bearing. The device is designed to protect against worker injury from an exposed rotating shaft or bearing. The device is also designed to mount around the rotating shaft or bearing in a manner that uses existing equipment mounting points. Hence, the device minimizes the cost associated with retroactively guarding a rotating shaft or bearing for a piece of existing equipment.

### CROSS-REFERENCE TO RELATED APPLICATIONS

None.

### FIELD OF THE INVENTION

The present disclosure is in the technical field of industrial protective devices.

### BACKGROUND OF THE INVENTION

Industrial equipment causes many workplace injuries. Currently, the United States Department of Labor, Mine Safety and Health Administration publishes “MSHA's Guide to Equipment Guarding”. The guide gives general recommendations on equipment guarding in the mining industry.

### BRIEF SUMMARY OF THE INVENTION

The present disclosure describes a device for guarding an end of a rotating shaft or bearing. The device is designed to protect against worker injury from an exposed rotating shaft or bearing. The device is also designed to mount around the rotating shaft or bearing in a manner that uses existing equipment mounting points. Hence, the device minimizes the cost associated with retroactively guarding a rotating shaft or bearing for a piece of existing equipment.

The device for guarding an end of a rotating shaft or bearing comprises: a protective guard which surrounds the volume around a rotating shaft or bearing; a first member which connects the protective guard to a first mounting point; and a second member which connects the protective guard to a second mounting point.

### BRIEF DESCRIPTION OF THE DRAWINGS

FIG. 1 shows an example from the MSHA's Guide to Equipment Guarding which is a cage protecting the volume around a pulley and shaft assembly.

FIG. 2 shows an isometric view of a protective guard.

FIG. 3 shows an exploded isometric view of an embodiment of the protective guard installed on a piece of equipment.

FIG. 4 shows a side view of an embodiment of a device for guarding an end of a rotating shaft or bearing installed on a piece of equipment.

FIG. 5 shows a top view of an embodiment of a device for guarding an end of a rotating shaft or bearing installed on a piece of equipment.

FIG. 6 shows an isometric view of an embodiment of a device for guarding an end of a rotating shaft or bearing installed on a piece of equipment.

### DETAILED DESCRIPTION OF THE INVENTION

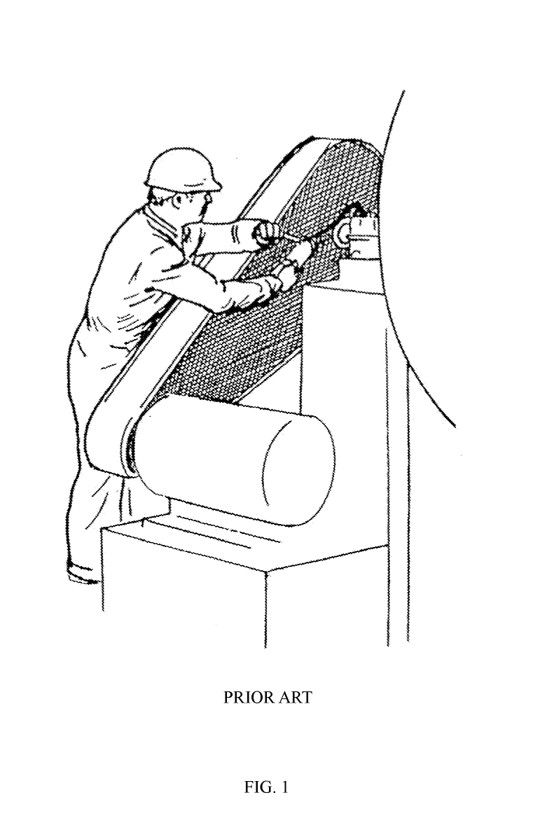

MSHA's Guide to Equipment Guarding gives general guidelines and numerous examples of equipment guarding. For example, FIG. 1 shows an example from the Guide which is a cage protecting the volume around a pulley and shaft assembly. The Guide does not discuss the mounting requirements of the cage. This type of cage protection is typically heavy and difficult to retroactively install on existing equipment. Also, this type of cage protection has specialized mounting requirements. New mounting points with support brackets may have to be welded or drilled onto the equipment, to properly secure the cage.

Recently, MSHA has begun to enforce protective requirements for an end of a rotating shaft or bearing. Since the end of a rotating shaft or bearing encompasses a small volume relative to a pulley and shaft assembly, retroactively installing a large protective cage is more than is necessary. Instead, what is needed is a smaller device capable of protecting the volume of the rotating shaft or bearing. In addition, the smaller device should be easier to mount and require less mounting support because of a lower bulk and weight.

The present disclosure describes a device for guarding an end of a rotating shaft or bearing. The device is designed to protect against worker injury from an exposed rotating shaft or bearing. The device is also designed to mount around the rotating shaft or bearing in a manner that uses existing equipment mounting points. Hence, the device minimizes the cost associated with retroactively guarding a rotating shaft or bearing for a piece of existing equipment.

An unexpected result and benefit of the device is that it doesn't require modification of the rotating shaft or bearing. One reason for the unexpected result is that the device is available in different sizes and configurations. A second reason is that the device is designed to mount around the rotating shaft or bearing in a manner that uses existing equipment mounting points.

The device for guarding an end of a rotating shaft or bearing comprises: a protective guard which surrounds the volume around a rotating shaft or bearing; a first member which connects the protective guard to a first mounting point; and a second member which connects the protective guard to a second mounting point.

The protective guard can be solid, perforated, or some combination of the two. The perforations can vary in size, depending upon plant or equipment requirements.

The protective guard can be constructed in different sizes, depending upon plant or equipment requirements.

In one embodiment, the protective guard has vent holes which are too small to allow a worker's finger to get caught in the protective guard. The vent holes allow air ventilation. The vent holes also allow visual inspection and cleaning of the protected volume without removal of the protective guard.

Typically, the protective guard is colored yellow to signify caution. However, other colors can be used as workplace safety or equipment guidelines dictate.

The protective guard is rigid and can be constructed of metal, plastic, or the like. A metal material of construction provides the benefit of high strength and thermal conductivity.

In one embodiment, a rotation sensor can be mounted on the protective guard to monitor the rotating shaft or bearing.

The first member mounts directly on an existing first mounting point. The first mounting point already exists to secure the equipment. Hence, the first member serves to connect the protective guard to the equipment without the need for any specialized mounting requirements.

The second member mounts directly on an existing second mounting point. The second mounting point already exists to secure the equipment. Hence, the second member serves to connect the protective guard to the equipment without the need for any specialized mounting requirements.

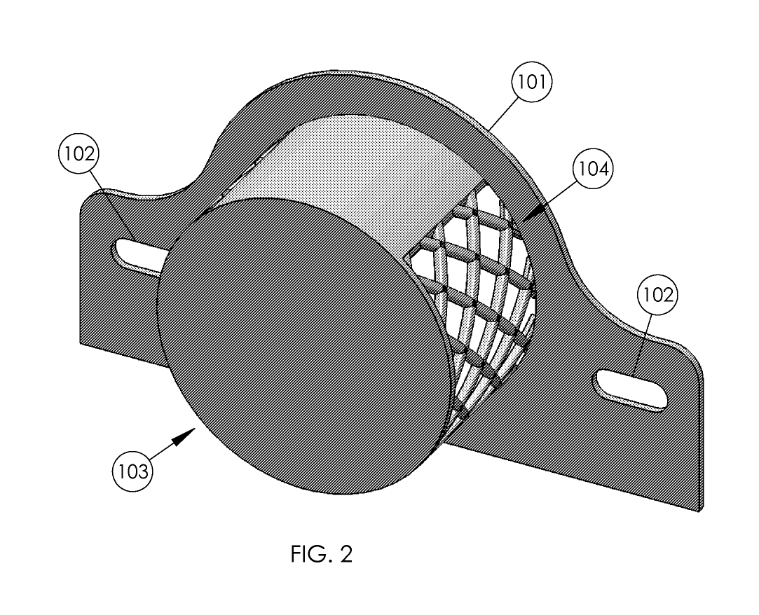

FIG. 2 shows an isometric view of a protective guard. An integrated mounting plate 101 mates with the equipment to be protected. The mounting plate 101 can be flat or another shape that matches the mounting surface of the equipment. The mounting plate 101 contains two holes 102 for attaching, one for each member. Integral with the mounting plate 101 is a protective cap 103. The protective cap 103 has sufficient volume and is of the proper shape to guard an end of a rotating shaft or bearing. In the embodiment shown, the protective cap 103 has a cylindrical shape. The protective cap 103 has vent holes 104 which allow air ventilation and cleaning of the end of a rotating shaft or bearing. The vent holes 104 are small enough to prevent a worker's finger from getting caught in a vent hole 104.

While FIG. 2 shows two holes 102, a different number of holes are possible to match a different number of members used for mounting. For example, four holes are possible for a larger protective guard which has four members connecting to four matching mounting points.

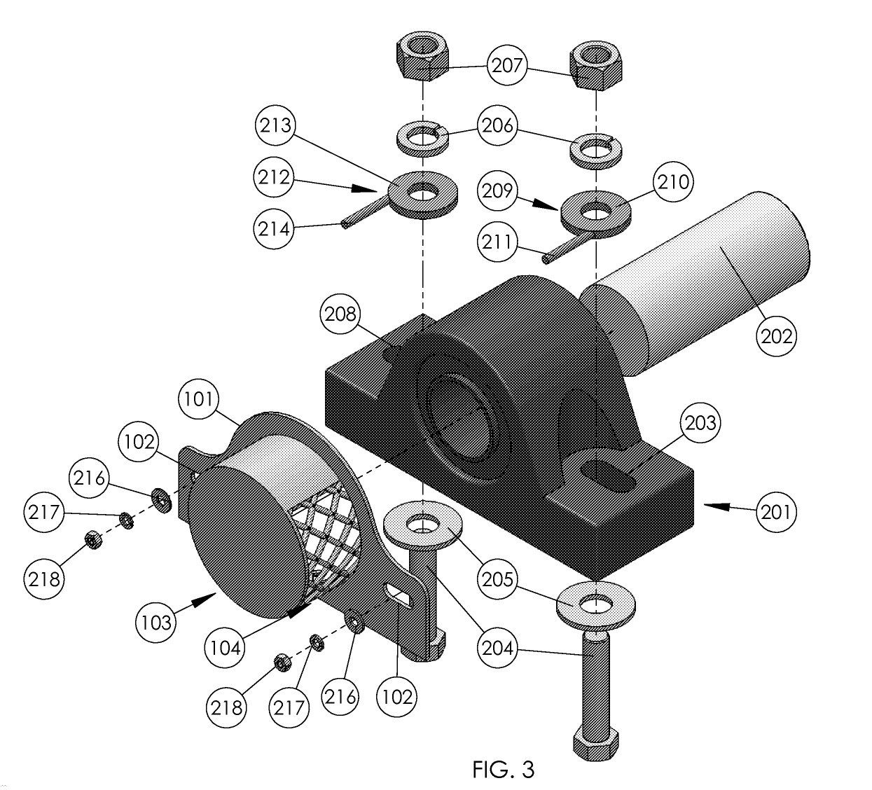

FIG. 3 shows an exploded isometric view of an embodiment of the protective guard installed on a piece of equipment. The protective guard comprises the mounting plate 101, holes 102, protective cap 103, and vent holes 104. The mounting plate 101 mates with and mounts on the side of a piece of equipment 201. The piece of equipment 201 includes a rotating shaft 202 which operates within the piece of equipment 201 and protrudes through it. A first equipment mounting point 203 is secured with a bolt 204, washer 205, lock washer 206, and nut 207. A second equipment mounting point 208 is also secured with a bolt 204, washer 205, lock washer 206, and nut 207. The first member 209 comprises a bolt mounting portion 210 and a protective cap mounting portion 211. Likewise, the second member 212 comprises a bolt mounting portion 213 and a protective cap mounting portion 214. The bolt mounting portions, 210 and 213, can comprise a washer embodiment which completely encircles the bolt 204 or a stake-on type embodiment which partially encircles the bolt 204. The protective cap 103 is secured onto the protective cap mounting portions, 211 and 213, with cap mounting washers 216, cap mounting lock washers 217, and cap mounting nuts 218.

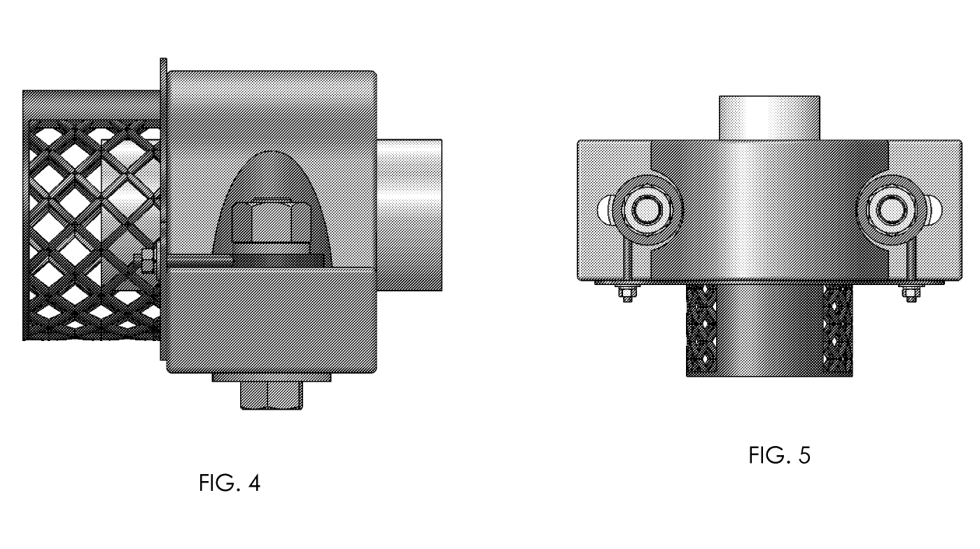

FIG. 4 shows a side view of an embodiment of a device for guarding an end of a rotating shaft or bearing installed on a piece of equipment.

FIG. 5 shows a top view of an embodiment of a device for guarding an end of a rotating shaft or bearing installed on a piece of equipment.

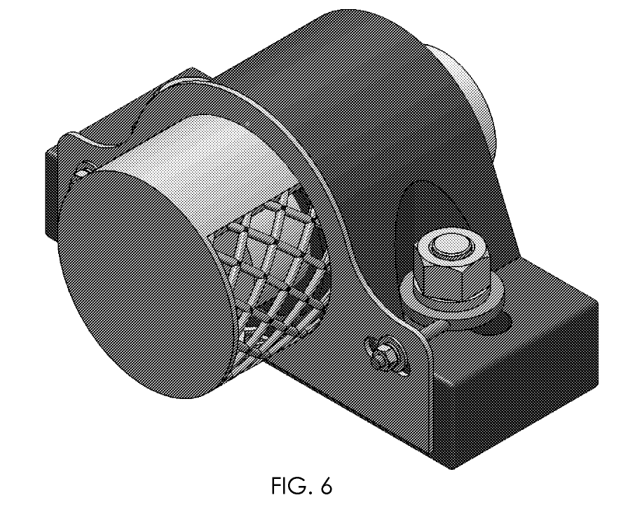

FIG. 6 shows an isometric view of an embodiment of a device for guarding an end of a rotating shaft or bearing installed on a piece of equipment.

While the present invention has been described herein with reference to an embodiment and various alternatives thereto, it should be apparent that the invention is not limited to such embodiments. Rather, many variations would be apparent to persons of skill in the art without departing from the scope and spirit of the invention, as defined herein and in the claims.

I claim:

1. A device for guarding an end of a rotating shaft or bearing, the device comprising:
a protective guard which surrounds the volume around a rotating shaft or bearing;
a first member which connects the protective guard to a first mounting point; and
a second member which connects the protective guard to a second mounting point.

2. The device of claim 1, wherein the protective guard has ventilation holes which are too small to allow injury to an adult human finger.

3. The device of claim 2, wherein the protective guard is colored to match plant safety or equipment requirements.

4. The device of claim 3, wherein the protective guard is rigid and constructed of a metal or metal alloy.

5. The device of claim 3, wherein the protective guard is rigid and constructed of a plastic.

6. The device of claim 1, wherein the first and second members comprise:
a bolt mounting portion which completely encircles a mounting bolt; and
a protective guard mounting portion.

7. The device of claim 1, wherein the first and second members comprise:
a bolt mounting portion which partially encircles a mounting bolt; and
a protective guard mounting portion.

8. The device of claim 1, wherein the protective guard is also used as a mounting point for a rotation sensor.

9. A device for guarding an end of a rotating shaft or bearing, the device comprising:
a protective guard which surrounds the volume around a rotating shaft or bearing; and
a plurality of members which connect the protective guard to a plurality of respective mounting points.

10. The device of claim 9, wherein the protective guard has ventilation holes which are too small to allow injury to an adult human finger.

11. The device of claim 10, wherein the protective guard is colored to match plant safety or equipment requirements.

12. The device of claim 11, wherein the protective guard is rigid and constructed of a metal or metal alloy.

13. The device of claim 11, wherein the protective guard is rigid and constructed of a plastic.

14. The device of claim 9, wherein the first and second members comprise:
a bolt mounting portion which completely encircles a mounting bolt; and
a protective guard mounting portion.

15. The device of claim 9, wherein the first and second members comprise:
a bolt mounting portion which partially encircles a mounting bolt; and
a protective guard mounting portion.

16. The device of claim 9, wherein the protective guard is also used as a mounting point for a rotation sensor.

17. A device for guarding an end of a rotating shaft or bearing, the device comprising:
a protective guard which surrounds the volume around a rotating shaft or bearing; and
a member which connects the protective guard to a mounting point.

18. The device of claim 17, wherein the protective guard is also used as a mounting point for a rotation sensor.
